(19) United States
(12) Patent Application Publication
(10) Pub. No.: US 2019/0213503 A1
(43) Pub. Date: Jul. 11, 2019

(54) IDENTIFYING A DEPLOYED MACHINE LEARNING MODEL

(71) Applicant: INTERNATIONAL BUSINESS MACHINES CORPORATION, Armonk, NY (US)

(72) Inventors: Jiri Navratil, Cortlandt Manor, NY (US); James W. Murdock, Amawalk, NY (US)

(21) Appl. No.: 15/863,982

(22) Filed: Jan. 8, 2018

(51) Int. Cl. G06N 99/00; G06F 9/54; G06F 17/30

(52) U.S. Cl. CPC G06N 99/005; G06F 17/30979; G06F 9/541

(57) ABSTRACT

A computer querying an application programming interface with each of multiple synthetic samples, each of the synthetic samples representing a separate sample assigned an original class from among multiple classes classified by a particular machine learning model and distorted to induce the particular machine learning model to misclassify the separate sample as a different class from among the classes. The computer accumulating, by the computer, a score of a number of results returned by the application programming interface that match an expected class label assignment of the different class for each of the synthetic samples. The computer, in response to the score exceeding a threshold, verifying, by the computer, that a service provided by the application programming interface is running the particular machine learning model.

### BACKGROUND

### 1. Technical Field

One or more embodiments of the invention relate generally to data processing and particularly to identifying a deployed machine learning model.

### 2. Description of the Related Art

Machine learning plays a central role in many artificial intelligence applications. One of the outcomes of the process of training machine learning applications is a data object referred to as a model, which is a parametric representation of the patterns inferred from training data. After a model is created, the model is deployed into one or more environments for use. At runtime, the model is the core of the machine learning system, based on a structure resulting from hours of development and large amounts of data.

### BRIEF SUMMARY

In one embodiment, a method is directed to querying, by a computer system, an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes. The method is directed to accumulating, by the computer system, a score of a number of results returned by the application programming interface that match an expected class label assignment of the different class for each of the plurality of synthetic samples. The method is directed to, in response to the score exceeding a threshold, verifying, by the computer system, that a service provided by the application programming interface is running the particular machine learning model.

In another embodiment, a computer system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprise program instructions to query an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes. The stored program instructions comprise program instructions to accumulate a score of a number of results returned by the application programming interface that match an expected class label assignment of the different class for each of the plurality of synthetic samples. The stored program instructions comprise program instructions, in response to the score exceeding a threshold, to verify that a service provided by the application programming interface is running the particular machine learning model.

In another embodiment, a computer program product comprises a computer readable storage medium having program instructions embodied therewith, wherein the computer readable storage medium is not a transitory signal per se. The program instructions are executable by a computer to cause the computer to receive, by the computer, one or more types of individual current usage from one or more battery enabled devices. The program instructions are executable by a computer to cause the computer to query, by the computer, an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes. The program instructions are executable by a computer to cause the computer to accumulate, by the computer, a score of a number of results returned by the application programming interface that match an expected class label assignment of the different class for each of the plurality of synthetic samples. The program instructions are executable by a computer to cause the computer to, in response to the score exceeding a threshold, verify, by the computer, that a service provided by the application programming interface is running the particular machine learning model.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates one example of a block diagram of a deployed model for a machine learning model in a service environment;

FIG. 2 illustrates one example of a block diagram of a signature training system for creating a set of synthetic samples by distorting training data used to train a proprietary model and training a synthetic sample signature of expected outputs for the set of synthetic samples, to identify the trained proprietary model

FIG. 3 illustrates one example of a block diagram of a synthetic sample signature created for identifying a particular trained proprietary model using a distorted subset of the training data for the particular trained proprietary model

FIG. 4 illustrates one example of a block diagram of a signature verification system for applying a synthetic sample signature to a service API to determine an identity of a machine learning model operating in a deployed system accessible via the service API;

FIG. 5 illustrates one example of a block diagram of a calibration system for calibrating a threshold applied by a signature verification system to determine whether the results of a synthetic sample signature probe of a proprietary model operating in a service environment verify that the identity of the proprietary model;

FIG. 6 illustrates one example of a block diagram of one example of a computer system in which one embodiment of the invention may be implemented;

FIG. 7 illustrates one example of a high-level logic flowchart of a process and computer program for creating a set of synthetic samples by distorting training data used to train a proprietary model and training a synthetic sample signature of expected outputs for the set of synthetic samples, to identify the trained proprietary model;

FIG. 8 illustrates one example of a high-level logic flowchart of a process and computer program for applying a synthetic sample signature to a service API to determine an identity of a machine learning model operating in a deployed system accessible via the service API; and

FIG. 9 illustrates one example of a high-level logic flowchart of a process and computer program for calibrating a threshold applied by a signature verification system to determine whether the results of a synthetic sample signature probe of a proprietary model operating in a service environment verify that the identity of the proprietary model.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

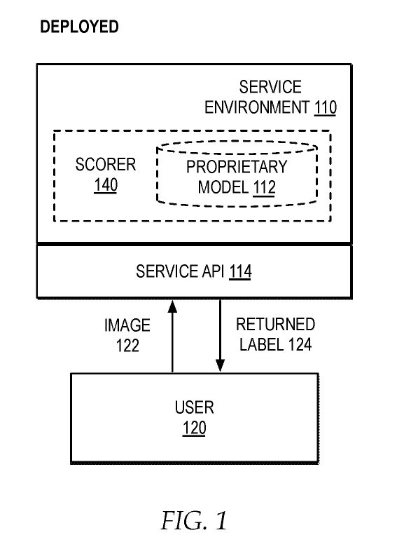

FIG. 1 illustrates a block diagram of one example of a deployed model for a machine learning model in a service environment.

In one example, machine learning may play a central role in artificial intelligence (AI) based applications, such as speech recognition, natural language processing, audio recognition, visual scene analysis, email filtering, social network filtering, machine translation, data breaches, optical character recognition, learning to rank, and bioinformatics. In one example, AI based applications may refer to computer systems, which may operate in one or more types of computing environments, carrying out tasks that require one or more types of analysis. In one example, machine learning may represent one or more types of AI that are based on training a machine with data and algorithms that and learn from and make predictions on data. One of the primary outcomes of the process of creating and training a machine learning environment is a data object, referred to as a model, built from sample inputs. In one example, a proprietary model 112 represents a data object of a machine learning environment, which has been created and trained from one or more sources of training data of sample inputs, and then deployed. In one example, proprietary model 112 may be a parametric representation of the patterns inferred from specific training data.

In one example, an entity may spend a significant amount of time training proprietary model 112. The entity may also release proprietary model 112 for deployment in one or more types of environments, subject to one or more usage restrictions specified by the entity. For example, an entity may release proprietary model 112 as authorized for non-commercial, public service uses, but for commercial service uses, require that the commercial service user enter into a licensing agreement with the entity for authorized use of proprietary model 112. In another example, an entity may release proprietary model 112 as authorized for use by registered services only and provide an interface through which a service planning to deploy an instance of proprietary model 112 in an environment may register with the entity to receive authorization to use the instance of proprietary model 112 in the environment. In another example, a service may initially register for an authorized use of proprietary model 112 at a cost per use, however if the service were to reverse engineer the data object of proprietary model 112 and recreate a model based on proprietary model 112, the recreated model may represent an unauthorized use of proprietary model 112 per a registration agreement.

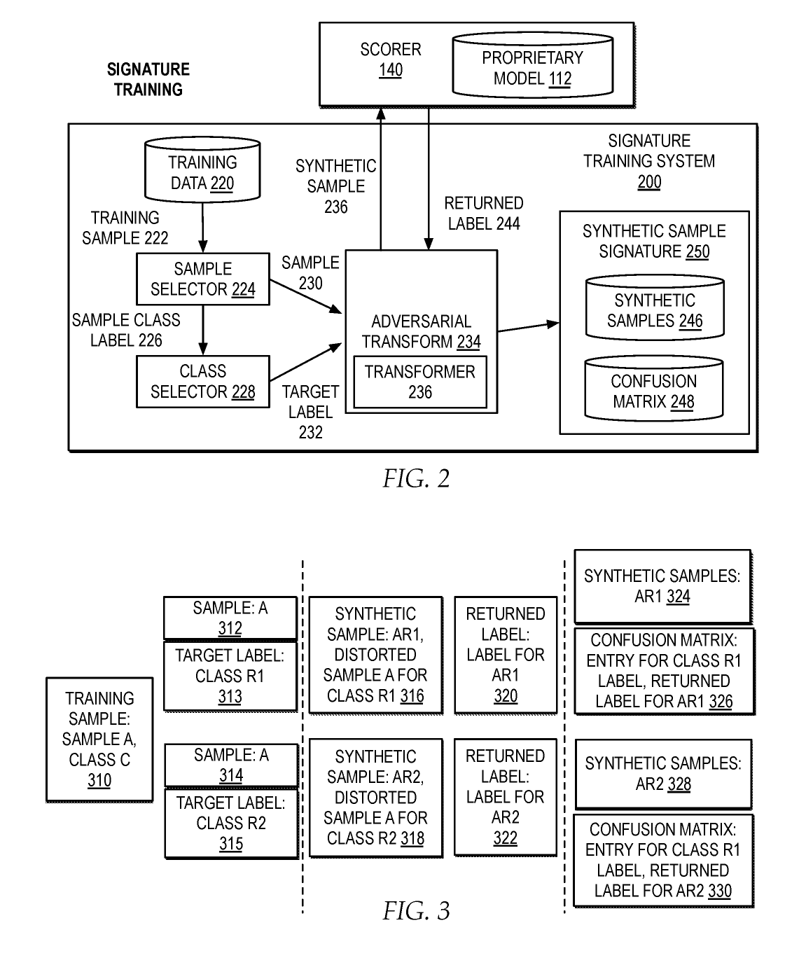

In one example, FIG. 1 illustrates an example of proprietary model 112 deployed with a scorer 140, or other model controller, in a service environment 110 for providing a service, such from as a cloud environment for providing a cloud service, which is accessible to end users through a service application programming interface (API) 114. In one example, as described with reference to FIG. 2, while training proprietary model 112, an entity may have direct access to proprietary model 112 through scorer 140. In one example, once proprietary model 112 is authorized for deployment by a third party and placed into service environments, such as service environment 110 for access as a service to users through service API 114, users may not be able to view what or if a proprietary model is providing the service provided through service API 114. In particular, service API 114 may limit user access to a service provided by service environment 110 through an input to and an output from service API 114, without identifying whether any particular proprietary model is deployed in service environment 110 or without identifying any particular proprietary model deployed in service environment 110. In one example, service environment 110 may also include multiple deployed configurations of proprietary models, accessible via service API 114.

In particular, in one example, service API 114 may provide a classification service to users, for classifying images. In one example, user 120 may represent any user that has access to the service provided by service environment 110, sending an API call to service API 114, with an image 112. In one example, service API 114 may pass image 122 to scorer 140. Scorer 140 may represent a model controller specified for evaluating proprietary model 112 by receiving test data inputs, running tests data inputs on proprietary model 112, and output a class label predicted by proprietary model 112. In particular, in the example in FIG. 1, to access the machine learning functionality of proprietary model 112, user 120 may be limited to access the service through an input to and an output from service API 114. For example, user 120 may send an image 122 to service API 114, for service API 114 to apply to proprietary model 112 to determine a class label to assign to image 122, and service API 114 may return the class label identifying the image to user 120 as returned label 124.

In one example, proprietary model 112 may represent an authorized use of proprietary model 112 or may represent an unauthorized use of proprietary model 112, however, once deployed in service environment 110, proprietary model 112 appears as a black box to user 120, where service environment 110, and proprietary model 112 operating within service environment 110, can only be viewed by user 120 in terms of the input and output to service API 114, without providing any knowledge of the internal workings of service environment 110. In particular, proprietary model 112 may appear as a black box to any particular user, whether the entity or any other user of the service provided through service API 114.

In one example, the entity that has proprietary rights to proprietary model 112 may desire to determine whether the service provided through service API 114 is using an instance of proprietary model 112 within service environment 110, such that if service environment 110 is using proprietary model 112 the entity may determine whether the user is authorized or whether the use of proprietary model 112 in service environment 110 is an unauthorized, infringing use. The entity, however does not have direct access inside service environment 110 to send inputs directly to scorer 140 to determine whether proprietary model 112 is an instance of the proprietary model released by the entity. While the entity may include a hidden mechanism into proprietary model 112 that would return a digital signature of proprietary model 112 in response to an explicit trigger, an explicit trigger that is detectable as different from a normal, valid input may also be more easily detectable by other parties and may be blocked or removed at the service API layer or other layer of service environment 110, by a party deploying proprietary model 112 in service environment 110 under an unauthorized use of proprietary model 112.

In the example, in the present invention, to enable the entity with control of the proprietary rights to proprietary model 112 to detect whether a service provided through service API 114 is providing the service by using an instance of proprietary model 112, where service environment 110 is a black box to user 120, after training proprietary model 112, but prior to deploying proprietary model 112, the entity may apply a signature training system to proprietary model 112, as described in FIG. 2, for creating a set of synthetic samples, virtually indistinguishable from normal, valid inputs, and train a set of expected outputs to the synthetic samples, on proprietary model 112. Once proprietary model 112 is deployed, the entity may apply a signature verification system to send probe inputs of the synthetic samples, which are virtually indistinguishable from normal, valid inputs, as image 122 to service API 114 and then test the corresponding output in returned label 124, to determine whether the output labels match expected output values for the probe inputs without sending an explicit trigger that is detectable by another party.

FIG. 2 illustrates a block diagram of one example of a signature training system for creating a set of synthetic samples by distorting training data used to train a proprietary model and training a synthetic sample signature of expected outputs for the set of synthetic samples, to identify the trained proprietary model.

In one example, one or more training systems may initially train proprietary model 112 using training data 220. In one example, training data 220 may include multiple samples, each assigned a separate class label of “N” target classes to be recognized by proprietary model 112. In one example, proprietary model 112, as trained, may represent a neural network for image recognition or other type of classification. In one example, proprietary model 112, as trained, may employ one or more types of classifiers, which classify inputs based on mathematical functions or algorithms applying the trained data in proprietary model 112 and predicts a class label for the input. In one example, one or more types of classifier may include, but are not limited to, a Naive Bayes classifier, a Logistic Regression classifier, and a Decision tree classifier. In one example, training data 220 may include a large corpus of samples, including, but not limited to, images, speech and text, which may also be proprietary to an entity and expensive to generate.

In one example, at runtime scorer 140 may evaluate proprietary model 112, receiving test data inputs, running the test data inputs on proprietary model 112 and outputting the class label predicted by proprietary model 112 for the data input, in order to measure whether the model assigns the correct class to the test data inputs. In particular, scorer 140 may represent a controller or module connected to an already trained machine learning model of proprietary model 112. In one example, a characteristic of machine learning models, such as proprietary model 112, may be that it is relatively sensitive to minor distortions of a few bits in images that cause misclassification, even after significant amounts of data are used in training data 220 and other robustness safeguards are applied. For example, for an image that includes a cat, and should be classified as a cat image, due to the sensitivity of machine learning models, the image may be slightly distorted by a few bits or a bit pattern in a way that will induce the classifier of proprietary model 112 to misclassify the image under the class of dog images, rather than under the class of cat images, 100% of the time. In one example, the slight distortion in an image that should be classified under a first class, but instead is misclassified under a second class, may be so minimal that the distortion is not visible to the human eye, but does induce proprietary model 112 to misclassify the image.

In one example, in order to create a set of synthetic samples that may be applied to identify proprietary model 112, signature training system 200 tests proprietary model 112, using one or more samples from training data 220, to create a synthetic sample signature 250. In one example, synthetic sample signature 250 may include a set of synthetic samples 246, created by an adversarial transform 234 transforming a subset of the real samples in training data 220. In one example, the subset of samples from training data 220 are transformed into synthetic samples 246 so that they minimally deviate from their valid counterparts, but deviate significantly enough to induce the classifier of proprietary model 112 to make a pre-determined classification error.

In one example, adversarial transform 234 may apply one or more types of transformation metrics. In one example, adversarial transform 234 may apply a separate distance metric specified for each type of classification. In one example, each distance metric may specify a number of pixels to alter in an image, the distance between the altered pixels, and the maximum change to each altered pixel. In one example, metrics may be further specified to select a distance metric that results in classification and passes a test performed by a person indicating perceptual similarity of the intended classification of an image and the image as transformed by adversarial transform 234.

In addition, in one example adversarial transform 234 may first detect the metrics of deviations in an image that result in misclassifications occurring and then apply the metrics of the deviation to other images to trigger a same type of misclassification, such as during a training phase of proprietary model 112 when defensive distillation control or other robustness controllers are applied to detect the types of deviation metrics that result in misclassifications. In particular, in some contexts of machine learning environments, adversarial transformations of images may be used by a third party to allow the third party to cause a system to take unwanted actions, by sending an image to the system that is adversarially transformed, by a minimal deviation, that intentionally induces a misclassification of the type of image by the system. In the present invention, adversarial transform 234 intentionally performs an adversarial transformation on a sample to generate a synthetic sample and tests the synthetic sample on proprietary model 112 to determine the classification of the synthetic sample in order to create an effective signature of proprietary model 112 that can be tested on proprietary model 112, once deployed, without detection by a third party.

In one example, during synthetic signature training by signature training system 200, proprietary model 112 may be fully accessible to adversarial transform 234 via a scorer 140, and the identity of proprietary model 112 is visible to signature training system 200, in contrast to FIG. 1 where the identity of the proprietary model deployed in service environment 110 is not visible to user 120 behind service API 114. In one example, signature training system 200 may generate synthetic sample signature 250 for use in identifying proprietary model 112 at future runtimes when proprietary model 112 is operating in a black box, as described with reference to FIG. 1. In one example, signature training of proprietary model 112 is described with respect to a model type that performs a task of classification, however in additional or alternate embodiments, signature training system 200 may perform signature training on models that perform additional or alternate types of tasks, including, but not limited to, detection and ranking.

In one example, a sample selector 224 of signature training system 200, may retrieve a training sample 222 from training data 220. In one example, training sample 222 may represent a subset of real samples from training data 220, which were used to train proprietary model 112. In one example, training sample 222 may include one or more objects, such as one or more images, for one or more classes of “N” total classes. In one example, for each class “C” and for each sample from that class, sample selector 224 may select a sample 222 from training data 220 and may send the particular object as sample 230 to an adversarial transform 234 of signature training system 200. In addition, for each class “C” and for each sample from that class, sample selector 224 may pass the class label “C” assigned to the selected sample object as sample class label 226 to class selector 228. In one example, class selector 228 may select a class label “R” of “N” classes, other than the class “C” identified in sample class label 226, and output selected class label “R” as a target label 232 to adversarial transform 234. In the example, a transformer 236 of adversarial transform 234 may apply a transformation to sample 230 to minimally distort sample 230 in a manner such that scorer 140 will classify the sample as class “R”. In one example, the minimal distortion applied by adversarial transform 234 may include a few bits or a pattern of bits that are distorted in sample 230. Adversarial transform 234 may output distorted sample 230 as synthetic sample 236 to scorer 140. In the example, signature training system 200 class selector 228 may send target label 232 to each of the “R” classes other than “C”, from among “N” classes, for a same sample from class “C”. Adversarial transform 234 may apply transformer 236 to each of the samples, for each of the other “R” classes received as input in target label 232 for sample 230, and may send each of the transformed samples as synthetic sample 236 to scorer 140.

In one example, scorer 140 may receive input test data from inputs of synthetic sample 236 from adversarial transform 234, apply the input test data to proprietary model 112, and return an output from proprietary model 112 to adversarial transform 234 as returned label 244. In the example where proprietary model 112 is a classification model, scorer 140 may output a predicted value for the class of the input sample, such as the class type of an image, and a probability of the predicted value, output as returned label 244, and may also return the probability of the predicted value. In other examples, where proprietary model 112 is a different type of classification model or other types of model, scorer 140 may output other types of values and may include one or more additional steps for managing output of multiple values, such as a linked list output for a ranking model.

In the example, adversarial transform 234 may organize each of the synthetic samples sent as synthetic sample 236 input to scorer 240, in a database of synthetic samples 246 of synthetic sample signature 250. In addition, adversarial transform 234 may organize each of the synthetic samples as corresponding to an element of a confusion matrix 248 of synthetic sample signature 250. In one example, confusion matrix 248 may represent a single C-by-C matrix or may represent multiple matrices. In one example, the class labels identified in returned label 244, for each of the synthetic samples in a C-by-C confusion matrix 248, may indicate whether a predicted target class type, specified by target label 232, matched a same class type in returned label 244 or whether a predicted target class type, specified by target label 232, matched a different class type in returned label 244, in addition to the probability of the predicted value returned by scorer 240.

In particular, while adversarial transform 234 may transform a training sample into a synthetic sample that is intended to trigger a particular misclassification, the actual classification triggered by a synthetic sample may vary from the intended misclassification. C-by-C confusion matrix 248 may reflect a true match or false match between an intended class classification for a synthetic sample and the resulting classification returned from proprietary model 112. In one example, even if the returned label from proprietary model 112 for a synthetic sample does not match the target label for the synthetic sample, C-by-C confusion matrix 248 records the misclassification and proprietary model 112 is most likely to repeat the same returned label for the same synthetic sample at runtime.

In one example, training system 200 may be provided as a service to an entity that has developed proprietary model 112 using training data 220. In one example, the entity may provide a trusted training service provider of signature training system 200 with training data 220 and with access to scorer 140. In one example, the trusted training service provider may generate synthetic sample signature 250 on behalf of the entity, applying adversarial transform 234 trained by the trusted training service provider, across multiple proprietary models. In one example, the trusted training service provider may develop adversarial transform 234 based on an additional service provided by the trusted service provider for testing proprietary models to detect weaknesses in the adversarial model, by detecting the types of adversarial transformations that would induce the proprietary model to misclassify an image, but that are the least detectable.

FIG. 3 illustrates a block diagram of one example of a synthetic sample signature created for identifying a particular trained proprietary model using a distorted subset of the training data for the particular trained proprietary model.

In one example, FIG. 3 illustrates an example of inputs and outputs within signature training system 200 for an example of training sample 222 illustrated “sample A, class C” 310, where the sample ID is “A” and the sample is identified as having a classification of “class C”.

In one example, sample selector 224 and class selector 228 may first select to send the training sample as sample “A” 312 with a target label 232 of “class R1” 313. Adversarial transform 234 may transform sample “A” and “class R1” into synthetic sample 236 of “AR1”, which is distorted for sample “A” for class “R1” 316. Scorer 240 may test synthetic sample “AR1” and return returned label 244 of “label for AR1” 320. In one example, adversarial transform 234 may add the synthetic sample to synthetic samples 246 as “AR1” 324 and may add an entry to confusion matrix 248 of “entry for class R1 label, returned label for AR1” 326, which adds a matrix entry for synthetic sample “AR1” to the C by C matrix of confusion matrix 248.

In one example, sample selector 224 and class selector 228 may next select to send the training sample as sample “A” 314 with a target label 232 of “class R2” 315. Adversarial transform 234 may transform sample “A” and “class R2” into synthetic sample 236 of “AR2”, which is distorted for sample “A” for class “R2” 318. Scorer 240 may test synthetic sample “AR2” and return returned label 244 of “label for AR2” 322. In one example, adversarial transform 234 may add the synthetic sample to synthetic samples 246 as “AR2” 328 and may add an entry to confusion matrix 248 of “entry for class R2 label, returned label for AR2” 328, which adds a matrix entry for synthetic sample “AR1” to the C by C matrix of confusion matrix 248.

For example, if proprietary model 242 provides classifications of animal images, “sample A, class C” 310, may represent an image of a cat, where “class C” is set to “cat”. In the first example, sample selector 224 and class selector 228 may first select sample “A” 312 and set target label 232 to “class R1” 313, where “class R1” is a classification of “dog”. In the first example, transformer 236 may minimally distort sample “A” in a manner such that proprietary model 112 is likely to misclassify “sample A” as “dog”, rather than “cat”, to create synthetic sample “AR1” 316. In one example, the returned label of “label for AR1” 320 may be set to “class R1” of “dog”, where when viewed by a person, synthetic sample “AR1” should be classified as “cat”, but due to the slight distortion, proprietary model 112 will consistently classify synthetic sample “AR1” as “dog”. The confusion matrix entry for “AR1” may include the matrix entry intersecting the “class R1” label of “dog” with the returned “label for AR1” of “dog”, with a percentage probability matching.

In the second example, sample selector 224 and class selector 228 may next select sample “A” 314 and set target label 232 to “class R2” 315, where “class R2” is a classification of “bird”. In the second example, transformer 236 may minimally distort sample “A” in a manner such that proprietary model 112 is likely to misclassify “sample A” as “bird”, rather than “cat”, to create synthetic sample “AR1” 318. In one example, the returned label of “label for AR2” 322 may be set to “class C” of “cat”, where when viewed by a person, synthetic sample “AR1” should be classified as “cat”, and despite the slight distortion set to trigger proprietary model 112 to misclassify synthetic sample “AR1” as “bird”, proprietary model 112 will consistently classify synthetic sample “AR1” as “cat”. The confusion matrix entry for “AR1” may include the matrix entry intersecting the “class R1” label of “bird” with the returned “label for AR1” of “cat”, with a percentage probability matching.

In the example, the returned “label for AR1” 320 and returned “label for AR2” 322 may match the corresponding “R” target label setting for each synthetic sample, may be set to the original “class C” setting for each synthetic sample, or may be set to an alternative class setting from among the N class settings. In particular, while transformer 236 may minimally distort sample “A” with an expected classification “class C” in a manner such that proprietary model 112 is likely to misclassify the distorted sample as another class, such as “R1”, proprietary model 112 may also return a returned label with the synthetic sample classified as the original “class C” or another one of the classes “N”.

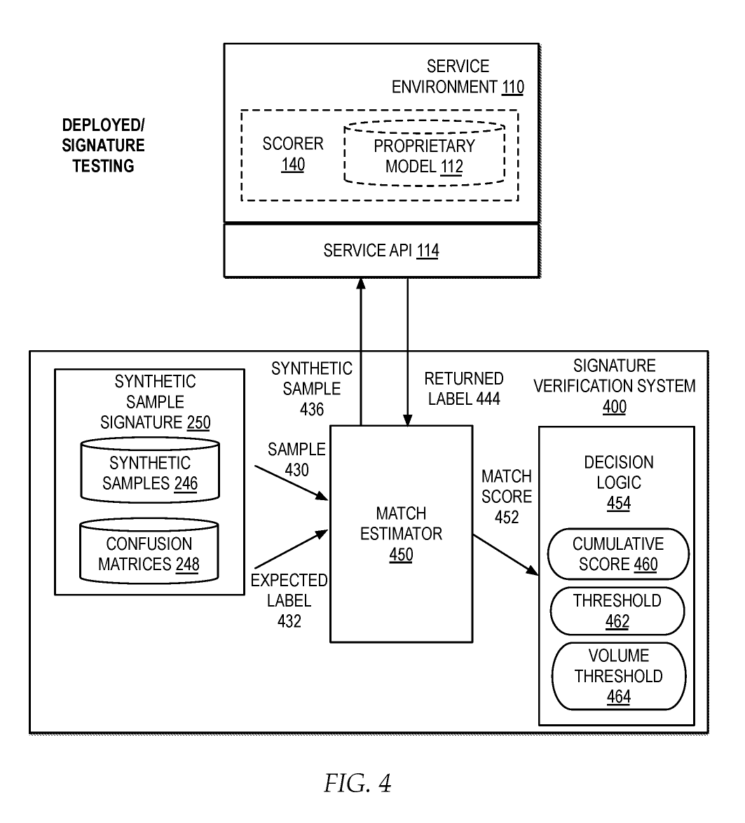

FIG. 4 illustrates a block diagram of one example of a signature verification system for applying a synthetic sample signature to a service API to determine an identity of a machine learning model operating in a deployed system accessible via the service API.

In one example, as previously describe in FIG. 1, one or more machine learning models, such as proprietary model 112, may be deployed one or more service environments, such as service environment 110, however users may only access the service provided by service environment 110 through service API 114. In one example, users interfacing with service API 114 may view service environment 110 as a black box, however the types of classes returned by service API 114 may include a selection or all of the “N” classifications classes supported by proprietary model 112. An entity which deployed proprietary model 112 may desire to verify whether the machine learning based service provided by service API 114, which returns at a least a selection of the “N” classification classes supported by proprietary model 112, is an instance of proprietary model 112.

In the example, service environment 110 may represent a black box to any user, such as user 120 of FIG. 1, only able to access service environment 110 through service API 114. In one example, when representing an entity that desires to verify the identity of one or more machine learning models deployed in service environment 100, signature verification system 400 may function as user 120, sending normal, valid inputs similar to any other user. In one example, signature verification system 400 may call service API 114 with image 122 set to synthetic sample 436, which is a normal, valid input image, and may receive returned label 444 returned by service API 114, in the same manner that service API 114 returns returned label 124 to any user sending service API calls to service API 114. By calling service API 114 with normal, valid inputs, service API 114 may not detect that the user sending synthetic sample 436 is signature verification system 400, sending the inputs to verify the identity of one or more machine learning models operating in service environment 110.

In one example, signature verification system 400 may implement a match estimator 450 that calls service API 114, with synthetic sample 436. In one example, match estimator 450 may first select of one or more synthetic samples from synthetic samples 246 of synthetic sample signature 250, as sample 430. In addition, for each synthetic sample, a returned label corresponding to each synthetic sample in confusion matrices 248 may be selected as an input to match estimator 450, as an expected label 432. In one example, for each of the inputs of sample 430 and the corresponding expected label 432, retrieved from synthetic sample signature 250, match estimator 450 may issue a query to service API 114, sending a test sample of synthetic sample 436. In one example, service API 114 may receive synthetic sample 436, as a normal, valid input and pass synthetic sample 436 to scorer 140 within service environment 110. In one example, scorer 140 may apply synthetic sample 436 to proprietary model 112, identify a classification label, and return the classification label, with a probability that the label is correct, through service API 114. Service API 114 may return the label as output returned label 444 to match estimator 450.

In one example, match estimator 450 may compare expected label 432 with returned label 444 and output match score 452 indicating whether expected label 432 and returned label 444 match or are mismatched to decision logic 454 of signature verification system 400. Decision logic 454 may receive each output of match score 452 for a selection or all of the synthetic samples in synthetic samples 246 and update a cumulative score 460, counting as success a match, and counting as failure a mismatch. In the example, decision logic 454 may count a number of match scores received and determine which a number of match scores received, updating cumulative score 460, reaches at least a number of match scores required in a volume threshold 464. In the example, once the number of match scores received reaches at least a number of match scores required in volume threshold 464, decision logic 454 may apply a threshold 462 to the cumulative score to determine a likelihood that synthetic sample signature 250 was trained on proprietary model 112, such that an entity with proprietary rights to proprietary model 112 may determine whether the service provided by service environment 110, through service API 114, is likely employing an instance of proprietary model 112. In one example, by signature verification system 400 determining whether the service provided by service environment 110, through service API 114, is likely employing an instance of proprietary model 112, service verification system 400 provides an entity that has trained synthetic sample signature 250 with a way to test the identity of proprietary models operating in service environment 110 to monitor for and respond to potentially unauthorized use of proprietary models.

In one example, threshold 462 and volume threshold 464 may be set to values that require a number of matches compiled in cumulative score 460 and the level of cumulative score 460 to reach levels that verify, with a particular confidence probability, that the model running in a black box of service environment 110 is an instance of the proprietary model 112 that was used to create and train synthetic sample signature 250. In one example, volume threshold 464 and threshold 462 may be applied to provide an additional layer of prediction to the probabilistic process, rather than applying an absolute value to account for data loss, noise, and other factors that may impact the calculation of cumulative score 460 at runtime. In one example, one or more factors that may impact cumulative score 460 reaching an expected score, may include, but are not limited to, noise on a channel between signature verification system 400 and service API 114, noise on channels within service environment 110, and front end processing on a network, by service API 114 or within service environment 110 that further distorts synthetic samples in calls to service API 114. In one example, threshold 462 and volume threshold 464 may be set to values such that if decision logic 454 indicates a positive result indicating a match between synthetic sample signature 250 and the service provided through service API 114, after reaching volume threshold 464 and applying threshold 462 to cumulative score 460, the positive result may indicate a level of confidence of the identity verification, such as 99% confidence proprietary model 112 is running in service environment 110, given runtime factors that may impact cumulative score 460 reaching an expected score.

In one example, signature verification system 400 may include each of threshold 462 and volume threshold 464 selectively set to achieve a predetermined level of confidence and may to set a predetermined level of synthetic samples required to be sampled. In another example, a user of signature verification system 400 may further specify a level of confidence that the user requests for identity verification by signature verification system 400, which directs signature verification system 400 to selectively adjust or directs adjustment of threshold 462 to achieve the level of confidence requested. In addition, a user of signature verification system 400 may further specify the volume value of volume threshold 464.

In one example, threshold 462 may be a static value selected for a particular type of classification model or a number of classes identified by the classification model. In another example, signature verification system 400 may trigger a calibration system, such as calibration system 500 in FIG. 5, to dynamically adjust threshold 462 based on cumulative scores of synthetic sample signature 250 run on other similar proprietary models. In another example, signature verification system 400 may dynamically adjust threshold 462 at runtime according to one or more factors related to a type of machine learning performed by a model, a type and number of synthetic samples available for testing by signature verification system 400, a type of service environment accessed through service API 114, a type of security requirement applied by service API 114 to calls to service API 114, a cost using a service provided through service API 114, and other factors that may impact the number and types of matches performed by match estimator 450 to calculate cumulative score 460.

In particular, in the example, the input probes of synthetic sample 436 from match estimator 450 to service API 114 may be virtually indistinguishable from normal, valid inputs. Service API 114 may handle synthetic sample 436 in the same way that any other normal, valid inputs would be handled. As a result, signature verification system 400 may test service environment 110 using input probes of synthetic sample 436 without providing any type of explicit trigger that service environment 110 may detect as a probe.

While the examples illustrated service environment 110 as a black box, with the access interface provided through service API 112, in additional or alternate examples, service environment 110 may provide additional or alternate types of inputs/output interfaces where the identity of proprietary model 112 is not directly accessible to the user and the user views the service environment in which proprietary model 112 operates, as a black box. In additional or alternate embodiments, service environment 110 may also represent an additional or alternate type of system environment. In additional or alternate embodiments, signature verification system 400 may apply synthetic sample signature 250 as input and may match estimate output from one or more additional types of interfaces through which the user accesses a service provided by proprietary model 112, but may not have direct access to proprietary model. In addition, in additional or alternate embodiments, signature verification system 400 may also apply synthetic sample signature 250 as input and may match estimate output from one or more additional types of interfaces through which the user has direct access to a proprietary model, such as in FIG. 2.

In one example, a trusted verification service provider may provide signature verification system 400 as a service to an entity. In one example, an entity requesting signature verification system service from a trusted verification service provider may authorize the trusted verification service provider to access synthetic sample signature 250 or may request that the trusted verification service provider store a copy of synthetic sample signature 250 in a persistent data structure of a cloud environment. In one example, the entity may also provide instructions for service API 114, for requesting verification of an identity of a model used in a particular service environment, or may request that the signature verification system automatically search for and identify potential service environments providing services with a same classification set or subset of the classes identified in synthetic sample signature 250. In one example, the trusted verification service provider may run one or more instances of signature verification system 400 as a service for applying synthetic sample signature 250 of an entity and return a result of a positive identity verification or a negative identity verification, to the entity.

FIG. 5 illustrates one example of a calibration system for calibrating a threshold applied by a signature verification system to determine whether the results of a synthetic sample signature probe of a proprietary model operating in a service environment verify that the identity of the proprietary model.

In one example, to calibrate threshold 462, applied to synthetic sample signature 250 for proprietary model 112, signature verification system 400 may create or select a cohort set 508 of one or more additional proprietary models, which may each have one or more configurations varying from proprietary model 112, but an identical selection of classification labels 506 as proprietary model 112. In one example, cohort set 508 may include a proprietary model A 512 controlled by a scorer 510, a proprietary model B 514 controlled by a scorer 514, and a proprietary model C 520 controlled by a scorer 518. In additional or alternate examples, cohort set 508 may include additional or alternate numbers of proprietary models.

In one example, a calibration controller 510 of calibration system 500 may direct signature verification system 400 to apply synthetic sample signature 250 to each of scorer 510, scorer 514, and scorer 518, through match estimator 450, as described with reference to FIG. 4. In one example, match estimator 450 may send calls to an API, as described with reference to FIG. 4, or may interface directly with a scorer, as described with reference to FIG. 3. In one example, decision logic 454 of signature verification system 400 may generate a separate cumulative score for each test on each of the proprietary models in cohort set 508. For example, for the test on proprietary model A 512 decision logic 454 calculates a cumulative score A 530, for the test on proprietary model B 516 decision logic 454 calculates a cumulative score B 532, and for the test on proprietary model C 520 decision logic 454 calculates a cumulative score C 534.

In one example, calibration controller 510 may store the cumulative scores of cohort set 508. In addition, calibration controller 510 may apply the cumulative scores of cohort set 508 to calibrate threshold 462 for proprietary model 112 to more accurately assess the likelihood of a cumulative score resulting from testing synthetic sample signature 250 on a black box environment being a true positive, indicating the black box environment is running proprietary model 112. In particular, calibration controller 510 may calibrate threshold 462 based on the cumulative scores of cohort set 508 and relying on the characteristic of machine learning models that adversarial transformations of a sample do not transfer to other similar proprietary models.

In one example, calibration controller 510 may apply one or more types of rules in determining the calibration of threshold 462 based on the cumulative scores and a selected confidence level. In particular, calibration controller 510 may apply rules that are based on the principle that adversarial transforms of training data in synthetic samples 246 is not likely to transfer to other similar proprietary models, which when applied in the present invention results in rules that may adjust the threshold 462 based on the size of the range of cumulative scores calculated for cohort set 508 and threshold 462 for a selected confidence level. In another example, calibration controller 510 may apply a rule that if one or more of the cumulative scores of cohort set 508 returns and is greater than 60% of cumulative score 460, then a determination may be made that the adversarial samples created for synthetic sample signature 250 may have transferred with a higher probability to other similar proprietary models and threshold 462 should be set higher than the greatest cumulative score calculated for cohort set 508. In another example, calibration controller 510 may apply a rule to average the cumulative scores for cohort set 508 and then set threshold 462 to a value that is a set percentage greater than the average. In another example, calibration controller 510 may apply a rule that additionally adjusts the threshold applied based on cumulative scores of cohort 508 based on the number of proprietary models tested in cohort 508. In another example, calibration controller 510 may calculate the average and standard deviation of the scores for cohort set 508 and then evaluate the difference between the score encountered and the average cohort score divided, or normalized, by the standard deviation of the cohort scores, allowing for a normalized assessment for a given test score of how many standard deviations the test score is away from the average cohort score.

In one example, calibration controller 510 may run prior to deployment of proprietary model 112. In another example, calibration controller 510 may dynamically run at one or more times after proprietary model 112 is deployed, including by not limited to, during runtime of signature verification system 400 testing a particular service API with synthetic sample signature 250.

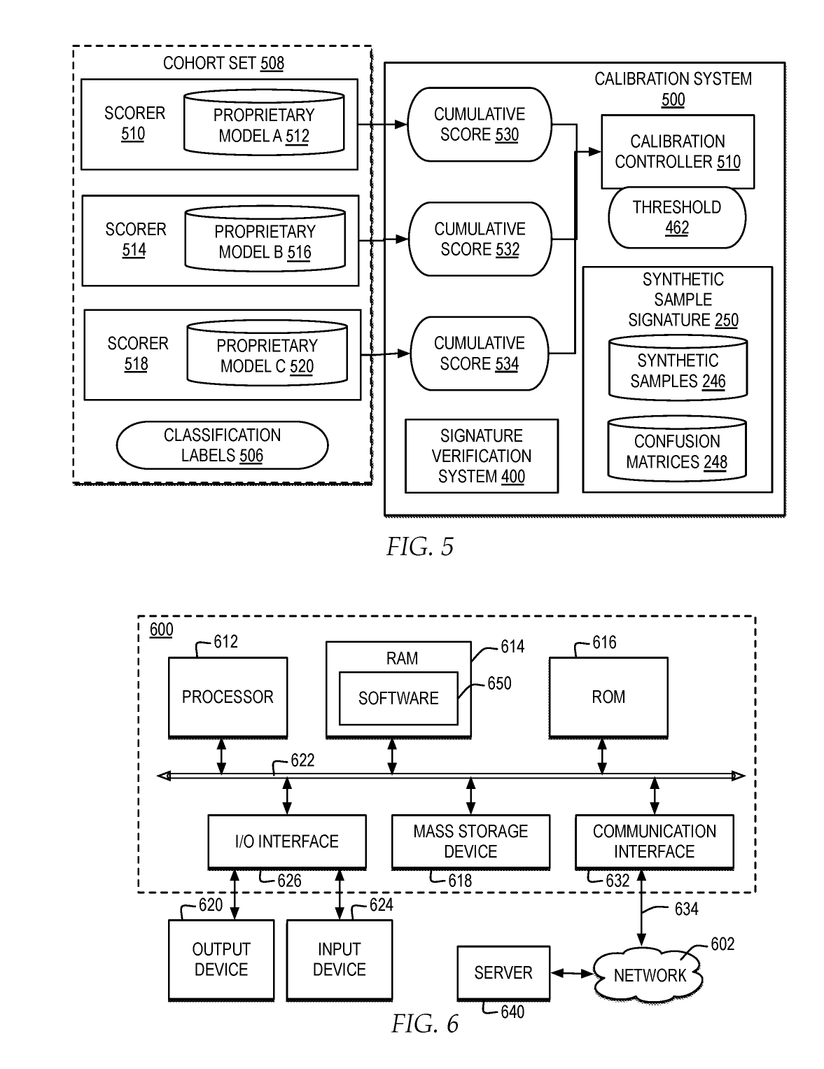

FIG. 6 illustrates a block diagram of one example of a computer system in which one embodiment of the invention may be implemented. The present invention may be performed in a variety of systems and combinations of systems, made up of functional components, such as the functional components described with reference to a computer system 600 and may be communicatively connected to a network, such as network 602.

Computer system 600 includes a bus 622 or other communication device for communicating information within computer system 600, and at least one hardware processing device, such as processor 612, coupled to bus 622 for processing information. Bus 622 preferably includes low-latency and higher latency paths that are connected by bridges and adapters and controlled within computer system 600 by multiple bus controllers. When implemented as a server or node, computer system 600 may include multiple processors designed to improve network servicing power.

Processor 612 may be at least one general-purpose processor that, during normal operation, processes data under the control of software 650, which may include at least one of application software, an operating system, middleware, and other code and computer executable programs accessible from a dynamic storage device such as random access memory (RAM) 614, a static storage device such as Read Only Memory (ROM) 616, a data storage device, such as mass storage device 618, or other data storage medium. Software 650 may include, but is not limited to, code, applications, protocols, interfaces, and processes for controlling one or more systems within a network including, but not limited to, an adapter, a switch, a server, a cluster system, and a grid environment.

Computer system 600 may communicate with a remote computer, such as server 640, or a remote client. In one example, server 640 may be connected to computer system 600 through any type of network, such as network 602, through a communication interface, such as network interface 632, or over a network link that may be connected, for example, to network 602.

In the example, multiple systems within a network environment may be communicatively connected via network 602, which is the medium used to provide communications links between various devices and computer systems communicatively connected. Network 602 may include permanent connections such as wire or fiber optics cables and temporary connections made through telephone connections and wireless transmission connections, for example, and may include routers, switches, gateways and other hardware to enable a communication channel between the systems connected via network 602. Network 602 may represent one or more of packet-switching based networks, telephony based networks, broadcast television networks, local area and wire area networks, public networks, and restricted networks.

Network 602 and the systems communicatively connected to computer 600 via network 602 may implement one or more layers of one or more types of network protocol stacks which may include one or more of a physical layer, a link layer, a network layer, a transport layer, a presentation layer, and an application layer. For example, network 602 may implement one or more of the Transmission Control Protocol/Internet Protocol (TCP/IP) protocol stack or an Open Systems Interconnection (OSI) protocol stack. In addition, for example, network 602 may represent the worldwide collection of networks and gateways that use the TCP/IP suite of protocols to communicate with one another. Network 602 may implement a secure HTTP protocol layer or other security protocol for securing communications between systems.

In the example, network interface 632 includes an adapter 634 for connecting computer system 600 to network 602 through a link and for communicatively connecting computer system 600 to server 640 or other computing systems via network 602. Although not depicted, network interface 632 may include additional software, such as device drivers, additional hardware and other controllers that enable communication. When implemented as a server, computer system 600 may include multiple communication interfaces accessible via multiple peripheral component interconnect (PCI) bus bridges connected to an input/output controller, for example. In this manner, computer system 600 allows connections to multiple clients via multiple separate ports and each port may also support multiple connections to multiple clients.

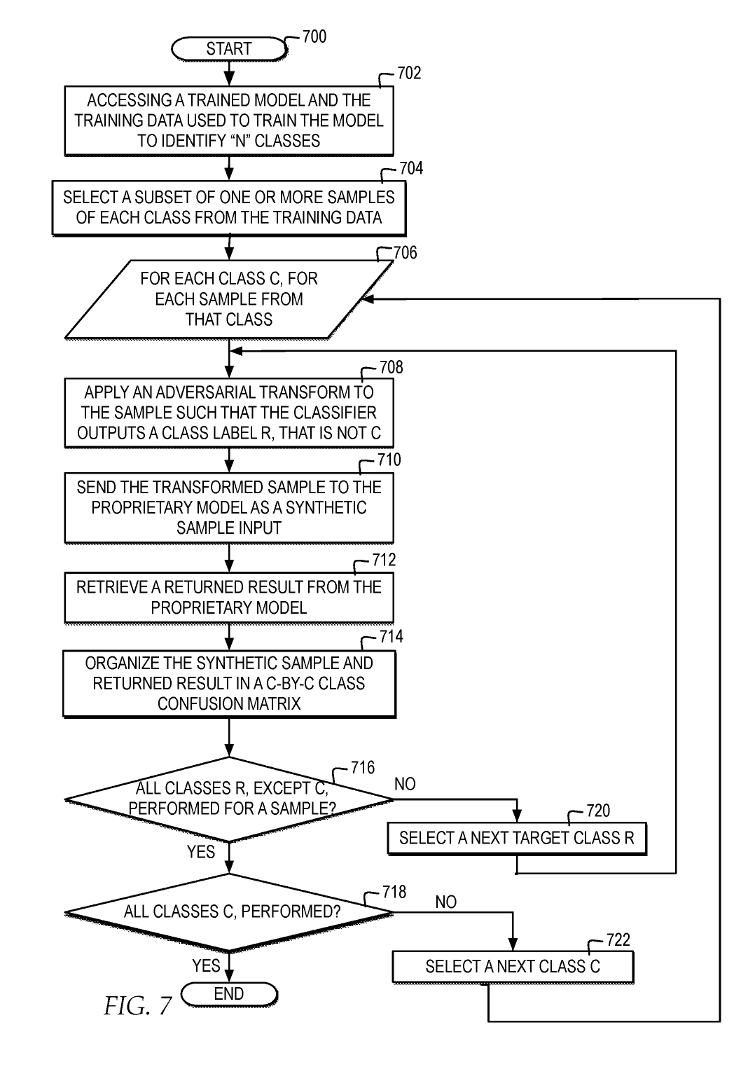

In one embodiment, the operations performed by processor 612 may control the operations of flowchart of FIGS. 7-9 and other operations described herein. Operations performed by processor 612 may be requested by software 650 or other code or the steps of one embodiment of the invention might be performed by specific hardware components that contain hardwired logic for performing the steps, or by any combination of programmed computer components and custom hardware components. In one embodiment, one or more components of computer system 600, or other components, which may be integrated into one or more components of computer system 600, may contain hardwired logic for performing the operations of flowcharts in FIGS. 7-9.

In addition, computer system 600 may include multiple peripheral components that facilitate input and output. These peripheral components are connected to multiple controllers, adapters, and expansion slots, such as input/output (I/O) interface 626, coupled to one of the multiple levels of bus 622. For example, input device 624 may include, for example, a microphone, a video capture device, an image scanning system, a keyboard, a mouse, or other input peripheral device, communicatively enabled on bus 622 via I/O interface 626 controlling inputs. In addition, for example, output device 620 communicatively enabled on bus 622 via I/O interface 626 for controlling outputs may include, for example, one or more graphical display devices, audio speakers, and tactile detectable output interfaces, but may also include other output interfaces. In alternate embodiments of the present invention, additional or alternate input and output peripheral components may be added.

With respect to FIG. 6, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory, stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely, propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the hardware depicted in FIG. 6 may vary. Furthermore, those of ordinary skill in the art will appreciate that the depicted example is not meant to imply architectural limitations with respect to the present invention.

FIG. 7 illustrates a high-level logic flowchart of a process and computer program for creating a set of synthetic samples by distorting training data used to train a proprietary model and training a synthetic sample signature of expected outputs for the set of synthetic samples, to identify the trained proprietary model.

In one example, the process and computer program start at block 700 and thereafter proceeds to block 702. Block 702 illustrates accessing a trained model and the training data used to train the model to identify “N” classes. Next, block 704 illustrates selecting a subset of one or more samples of each class from the training data. Thereafter, block 706 illustrates performing additional steps for each class “C”, for each sample from that class. Next, block 708 illustrates applying an adversarial transform to the sample such that the classifier outputs a class label “R”, that is not “C”. Thereafter, block 710 illustrates sending the transformed sample to the proprietary model as a synthetic sample input. Next, block 712 illustrates retrieving a result from the proprietary mode. Thereafter, block 714 illustrates organizing the synthetic sample and returned result in a C-by-C confusing matrix, and the process passes to block 716.

Block 716 illustrates a determination whether all classes “R”, except “C”, have been performed for a sample. At block 716, if not all classes “R”, except “C”, have been performed for a sample, then the process passes to block 720. Block 720 illustrates selecting a next target class “R”, and the process returns to block 708.

Returning to block 716, at block 716, if all classes “R”, except “C”, have been performed for a sample, then the process passes to block 718. Block 718 illustrates a determination whether all classes “C” have been performed. At block 718, if all classes “C” have been performed, then the process ends. Otherwise, at block 718, if not all classes “C” have been performed, then the process passes to block 722. Block 722 illustrates selecting a next class “C”, and the process returns to block 706.

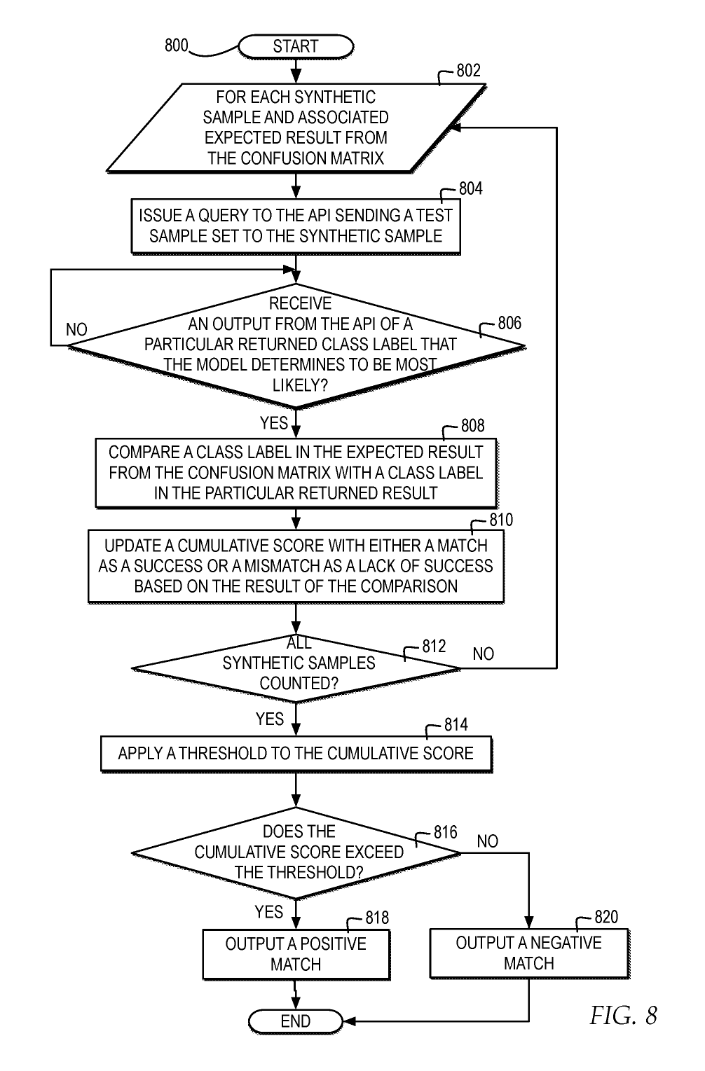

FIG. 8 illustrates a high-level logic flowchart of a process and computer program for applying a synthetic sample signature to a service API to determine an identity of a machine learning model operating in a deployed system accessible via the service API.

In one example, the process and computer program start at block 800 and thereafter proceeds to block 802. Block 802 illustrates a step performed for each synthetic sample and associated expected result from the confusion matrix. Next, block 804 illustrates issuing a query to the API sending a test sample set to the synthetic sample. Thereafter, block 806 illustrates a determination whether an output from the API is received of a particular returned class label that the model determines to be the most likely. At block 806, if an API output is received, then the process passes to block 808.

Block 808 illustrates comparing a class label in the expected result from the confusion matrix with a class label in the particular returned result from the API. Next, block 810 illustrates updating a cumulative score with either a match as a success or a mismatch as a lack of success, based on the result of the comparison. Thereafter, block 812 illustrates a determination whether all synthetic samples are counted. At block 812, if not all synthetic samples have been counted, then the process returns to block 802. Otherwise, at block 812, if all synthetic samples have been counted, then the process passes to block 814.

Block 814 illustrates applying a threshold to the cumulative score. Next, block 816 illustrates a determination whether the cumulative score exceeds the threshold. At block 816, if the cumulative score exceeds the threshold, then the process passes to block 818. Block 818 illustrates outputting a positive match, and the process ends. Otherwise, returning to block 816, at block 816, if the cumulative score exceeds the threshold, then the process passes to block 820. Block 820 illustrates outputting a positive match, and the process ends.

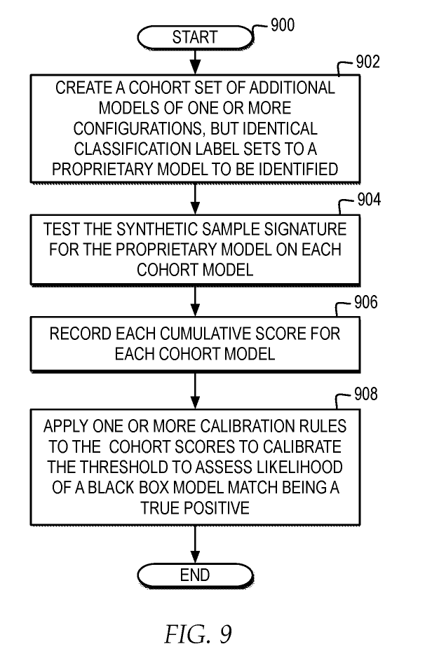

FIG. 9 illustrates a high-level logic flowchart of a process and computer program for calibrating a threshold applied by a signature verification system to determine whether the results of a synthetic sample signature probe of a proprietary model operating in a service environment verify that the identity of the proprietary model.

In one example, the process and computer program start at block 900 and thereafter proceeds to block 902. Block 902 illustrates creating a cohort set of additional models of one or more configurations, but identical classification label sets to the proprietary model to be identified. Next, block 904 illustrates testing the synthetic sample signature for the proprietary model on each cohort model. Thereafter, block 906 illustrates recording each cumulative score for each cohort model. Next, block 908 illustrates applying one or more calibration rules to the cohort scores to calibrate the threshold to assess likelihood of a black box model match being a true positive, and the process ends.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method comprising:
querying, by a computer system, an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes;
accumulating, by the computer system, a score of a number of results returned by the application programming interface that match an expected class label assignment of the different class for each of the plurality of synthetic samples; and
in response to the score exceeding a threshold, verifying, by the computer system, that a service provided by the application programming interface is running the particular machine learning model.

2. The method according to claim 1, further comprising:
sending, by the computer system, a separate query call to the application programming interface for each of the plurality of synthetic samples, wherein a user requesting to query the application programming interface with the plurality of synthetic samples is only able to access the service through queries to the application programming interface; and
receiving, by the computer system, an output from the application programming interface for each separate query call comprising a result label of one of the plurality of classes.

3. The method according to claim 1, wherein accumulating, by the computer system, a score of a number of results returned by the application programming interface that match an expected class label assignment of the different class for each of the plurality of synthetic samples further comprises:
accumulating, by the computer system, the score of the number of results returned by the application programming interface that match an expected class label assignment associated with each of the plurality of synthetic samples in a matrix of expected class labels, the matrix of expected class labels created from a plurality of results of applying the plurality of synthetic samples to the particular machine learning model prior to deployment.

4. The method according to claim 3, wherein accumulating, by the computer system, the score of the number of results returned by the application programming interface that match an expected class label assignment associated with each of the plurality of synthetic samples in a matrix of expected class labels, the matrix of expected class labels created from a plurality of results of applying the plurality of synthetic samples to the particular machine learning model prior to deployment further comprises:
in response to each result returned by the application programming interface that matches the expected class label in the matrix of expected class labels associated with a selection of the plurality of synthetic samples, updating, by the computer system, the cumulative score with a success; and
in response to each result returned by the application programming interface that does not match the expected class label in the matrix of expected class labels associated with an additional selection of the plurality of synthetic samples, updating, by the computer system, the cumulative score with lack of success.

5. The method according to claim 1, further comprising:
receiving, by the computer system, a selection from a user of a percentage probability of certainty requested; and
dynamically adjusting, by the computer system, the threshold to a level that requires the score to reach a level of certainty that the service provided by the application programming interface is running the particular machine learning model reaches the percentage probability of certainty requested.

6. The method according to claim 1, further comprising:
creating, by the computer system, a cohort set of a plurality of additional machine learning models of one or more configuration that classify the same plurality of classes as the particular machine learning model;
running, by the computer system, the plurality of synthetic samples on each of the plurality of additional machine learning models;
for each of the plurality of additional machine learning models, accumulating, by the computer system, a separate score of a separate number of results that match the expected class label assignment of the different class for each of the plurality of synthetic samples; and
applying, by the computer system, one or more calibration rules to each separate score to calibrate the threshold to assess the likelihood that the service provided by the application programming interface is running the particular machine learning model.

7. The method according to claim 1, wherein querying, by the computer system, an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes further comprising:
querying, by the computer system, the application programming interface with each of the plurality of synthetic samples as normal, valid inputs to the application programming interface that are not detectable by the application programming interface as test inputs to verify an identity of the particular machine learning model deployed and running behind the application programming interface.

8. The method according to claim 1, wherein in response to the score exceeding a threshold, verifying, by the computer system, that a service provided by the application programming interface is running the particular machine learning model further comprises:
in response to the score exceeding a threshold, verifying, by the computer system, by a percentage of probability associated with the threshold, that the service provided by the application programming interface is running the particular machine learning model.

9. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions to query an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes;
program instructions to accumulate a score of a number of results returned by the application programming interface that match an expected class label assignment of the different class for each of the plurality of synthetic samples; and
program instructions, in response to the score exceeding a threshold, to verify that a service provided by the application programming interface is running the particular machine learning model.

10. The computer system according to claim 8, wherein the program instructions further comprise:
program instructions to send a separate query call to the application programming interface for each of the plurality of synthetic samples, wherein a user requesting to query the application programming interface with the plurality of synthetic samples is only able to access the service through queries to the application programming interface; and
program instructions to receive an output from the application programming interface for each separate query call comprising a result label of one of the plurality of classes.

11. The computer system according to claim 8, wherein the program instructions to accumulate a score of a number of results returned by the application programming interface that match an expected class label assignment of the different class for each of the plurality of synthetic samples further comprise:
program instructions to accumulate the score of the number of results returned by the application programming interface that match an expected class label assignment associated with each of the plurality of synthetic samples in a matrix of expected class labels, the matrix of expected class labels created from a plurality of results of applying the plurality of synthetic samples to the particular machine learning model prior to deployment.

12. The computer system according to claim 11, wherein the program instructions to accumulate the score of the number of results returned by the application programming interface that match an expected class label assignment associated with each of the plurality of synthetic samples in a matrix of expected class labels, the matrix of expected class labels created from a plurality of results of applying the plurality of synthetic samples to the particular machine learning model prior to deployment further comprise:
program instructions, in response to each result returned by the application programming interface that matches the expected class label in the matrix of expected class labels associated with a selection of the plurality of synthetic samples, to update the cumulative score with a success; and
program instructions, in response to each result returned by the application programming interface that does not match the expected class label in the matrix of expected class labels associated with an additional selection of the plurality of synthetic samples, to update the cumulative score with lack of success.

13. The computer system according to claim 8, wherein the program instructions further comprise:
program instructions to receive a selection from a user of a percentage probability of certainty requested; and
program instructions to dynamically adjust the threshold to a level that requires the score to reach a level of certainty that the service provided by the application programming interface is running the particular machine learning model reaches the percentage probability of certainty requested.

14. The computer system according to claim 8, wherein the program instructions further comprise:
program instructions to create a cohort set of a plurality of additional machine learning models of one or more configuration that classify the same plurality of classes as the particular machine learning model;
program instructions to run the plurality of synthetic samples on each of the plurality of additional machine learning models;
for each of the plurality of additional machine learning models, program instructions to accumulate a separate score of a separate number of results that match the expected class label assignment of the different class for each of the plurality of synthetic samples; and
program instructions to apply one or more calibration rules to each separate score to calibrate the threshold to assess the likelihood that the service provided by the application programming interface is running the particular machine learning model.

15. The computer system according to claim 8, wherein the program instructions to query an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes further comprise:
program instructions to query the application programming interface with each of the plurality of synthetic samples as normal, valid inputs to the application programming interface that are not detectable by the application programming interface as test inputs to verify an identity of the particular machine learning model deployed and running behind the application programming interface.

16. The computer system according to claim 8, wherein the program instructions, in response to the score exceeding a threshold, to verify that a service provided by the application programming interface is running the particular machine learning model further comprise:
program instructions, in response to the score exceeding a threshold, to verify by a percentage of probability associated with the threshold, that the service provided by the application programming interface is running the particular machine learning model.

17. A computer program product comprises a computer readable storage medium having program instructions embodied therewith, wherein the computer readable storage medium is not a transitory signal per se, the program instructions executable by a computer to cause the computer to:
query, by the computer, an application programming interface with each of a plurality of synthetic samples, each of the plurality of synthetic samples representing a separate sample assigned an original class from among a plurality of classes classified by a particular machine learning model and distorted to induce the particular machine learning model to misclassify the separate sample as a different class from among the plurality of classes;
accumulate, by the computer, a score of a number of results returned by the application programming interface that match an expected class label assignment of the different class for each of the plurality of synthetic samples; and
in response to the score exceeding a threshold, verify, by the computer, that a service provided by the application programming interface is running the particular machine learning model.

18. The computer program product according to claim 17, further comprising the program instructions executable by a computer to cause the computer to:
send, by the computer, a separate query call to the application programming interface for each of the plurality of synthetic samples, wherein a user requesting to query the application programming interface with the plurality of synthetic samples is only able to access the service through queries to the application programming interface; and
receive, by the computer, an output from the application programming interface for each separate query call comprising a result label of one of the plurality of classes.

19. The computer program product according to claim 17, further comprising the program instructions executable by a computer to cause the computer to:
accumulate, by the computer, the score of the number of results returned by the application programming interface that match an expected class label assignment associated with each of the plurality of synthetic samples in a matrix of expected class labels, the matrix of expected class labels created from a plurality of results of applying the plurality of synthetic samples to the particular machine learning model prior to deployment.

20. The computer program product according to claim 19, further comprising the program instructions executable by a computer to cause the computer to:
in response to each result returned by the application programming interface that matches the expected class label in the matrix of expected class labels associated with a selection of the plurality of synthetic samples, update, by the computer, the cumulative score with a success; and
in response to each result returned by the application programming interface that does not match the expected class label in the matrix of expected class labels associated with an additional selection of the plurality of synthetic samples, update, by the computer, the cumulative score with lack of success.
